(19) United States
(12) Patent Application Publication
(10) Pub. No.: US 2007/0080473 A1
(43) Pub. Date: Apr. 12, 2007

(54) Manufacturing methods for MEMS element and optical modulator

(75) Inventor: Jae-Wook Jang, Seongnam-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon-si (KR)

(21) Appl. No.: 11/546,206

(22) Filed: Oct. 10, 2006

(30) Foreign Application Priority Data
Sep. 25, 2006 (KR) 10-2006-0093043
Oct. 10, 2005 (KR) 10-2005-0094962

(51) Int. Cl. B29D 11/00

(52) U.S. Cl. 264/1.9

(57) ABSTRACT

A manufacturing method for a MEMS element having a flat surface, comprising: (a) depositing a first layer on a substrate, a center portion of the first layer being spaced-apart from the substrate by a predetermined gap; (b) depositing a second layer on the first layer, the inner stresses in the first and second layers having opposite properties; and (c) heat-treating the first and second layers, so that the inner stresses in them have same properties.

### BACKGROUND

1. Technical Field

The present invention relates to a MEMS element, in particular, to a method for manufacturing a MEMS element through a heat-treatment, whereby the MEMS element can have a flat operating surface composed of two or more layers and spaced from a substrate by a predetermined gap.

2. Description of the Related Art

With advances in micro technologies, MEMS elements fabricated by so called MEMS (Micro Electro Mechanical System) technologies and micro devices using these MEMS elements have received attentions.

The MEMS element refers to a micro structural body formed on a substrate such as a silicon substrate, and a glass substrate, etc., and is composed of a driving part outputting driving power and a semiconductor integrated circuit controlling the driving part, which electrically and mechanically combined. The driving part, having a mechanical structure, is assembled to form the MEMS element, and driven electrically by Coulomb force generated between electrodes.

Examples of applications, in which the MEMS technology or the MEMS element is applied, include an acceleration gauge, a pressure sensor, an inkjet head, heads for hard disks, a projection display, and a scanner, etc. Also, together with advances in optical communication technologies, interests in components for the optical communication having high performance are growing.

Especially, those interests are focused on a space type optical modulator using a switching technique, where a micro-mirror is driven by a MEMS type actuator. Such an optical modulator has advantages in high speed, parallel processing, and large capacity information processing.

Progressed are studies on a binary-phase filter design, an optical logic gate, an optical amplifier, and an optical element, etc. Particularly, the space optical modulator is employed in such fields as optical memories, optical displays, printer, optical interconnections, holograms, and displays, etc.

FIGS. 1 and 2 illustrate typical configurations of a MEMS element, which uses optical reflection or diffraction, and is applied to an optical switch and an optical modulator.

In FIG. 1 is illustrated a MEMS element 10 comprising a substrate 1, a substrate side electrode 2 formed on the substrate 1, a beam 5 having a beam bolster 4 and a driver side electrode 3 disposed in parallel to substrate side electrode 2 to face each other, and a supporter 6 supporting a first end of the beam 5. The beam 5 is electrically insulated from the substrate side electrode 2 by an air gap 7 formed therebetween.

The beam 5 of the MEMS element 10 in FIG. 1 inclines due to an electrostatic attractive force generated between the beam 5 and the substrate side electrode 2 in correspondence with a voltage difference between the substrate side electrode 2 and the driver side electrode 3. As illustrated in solid and dotted lines in FIG. 1, the beam 5 has parallel and inclined states with respect to the substrate side electrode 2.

As shown in FIG. 2, another exemplary MEMS element 20 comprises a substrate 21, a substrate side electrode 22 formed on the substrate 21, and a beam 23 crossing over the substrate side electrode 22 in a bridge shape. The beam 23 is electrically insulated from the substrate side electrode 22 by an air gap 26 formed therebetween.

The beam 23 is composed of a bridge part 24, which is spaced-apart from the substrate side electrode 22 by a certain distance to be laid across it in a bridge shape, and a driver side electrode 25 formed on the bridge part 24 in parallel to the substrate side electrode 22 to face each other.

The beam 23 of the MEMS element 20 in FIG. 2 bends due to an electrostatic attractive force generated between the beam 23 and the substrate side electrode 22 in correspondence with a voltage difference between the substrate side electrode 22 and the driver side electrode 25. As illustrated in solid and dotted lines in FIG. 2, the beam 23 has parallel and bent states with respect to the substrate side electrode 22.

In the MEMS element 10, 20 shown in FIGS. 1 and 2, lights may be projected on separate micro-mirror layers deposited on the beam 5, 23, or on the driver side electrode 3, 25 functioning also as a micro-mirror, and the lights are reflected to different directions according to a driving position of the beam 5, 23, changing due to the voltage difference between the electrodes. Thus, the MEMS element 10, 20 can function as an optical switch by detecting the lights reflected to a particular direction.

Furthermore, the MEMS element 10, 20 can be applied as an optical modulator modulating the intensity of light. When the MEMS element 10, 20 uses the optical reflection law, it vibrates the beam 5, 23 by changing a voltage difference between the electrodes. This changes the amount of the lights per unit time reflected to a certain direction, thereby modulating the intensity of lights.

When the MEMS element 10, 20 uses the optical diffraction law, a plurality of beams 5, 23 are disposed in parallel with respect to the common substrate side electrode 2, 22 to form the optical modulator. A voltage difference between odd numbered beams 5, 23 and the common substrate side electrode 2, 22, is different from that between even numbered beams 5, 23 and the common substrate side electrode 2, 22, and therefore a gap between odd numbered beams 5, 23 and the common substrate side electrode 2, 22, is different from that between the even numbered beams 5, 23 and the common substrate side electrode 2, 22. Due to this gap difference, the lights are diffracted, resulting in modulation in the intensity of the lights reflected from the driver side electrode. Here, the aforementioned optical modulator is based on a space optical modulation principle.

FIG. 3 is a vertical sectional view of a depressed type piezoelectric optical modulator 30 as another MEMS element.

As shown in FIG. 3, the depressed type piezoelectric optical modulator 30 comprises a silicon substrate 31 and an element A.

Incident lights are reflected and diffracted by a micro-mirror layer formed on an upward side of the silicon substrate 31, on the surface of which an insulation layer 32 is deposited. To provide the element A an air gap, the silicon substrate 31 has a depressed part, at both sides of which both ends of the element A are adhered. The element A is a bar or ribbon shape, and comprises a lower supporter 33, a center portion of which is spacedly located over the depressed part of the silicon substrate 31, and moves upward and downward. Also, the element A comprises lower electrode layers 34 deposited on both ends of the lower supporter 33, piezoelectric material layers 35 deposited on the lower electrode layers 34 and delivering driving powers to the lower supporter 33 by being contracted and expanded due to a voltage applied to their both sides, and upper electrode layers 36 deposited on the piezoelectric material layers 35 and supplying a piezoelectric voltage to the piezoelectric material layers 35 together with the lower electrode layers 34.

Besides the depressed type, a protrusion type optical modulator having a floating element spaced from a silicon substrate 31 by a certain distance can also be used.

In order for one element A to express the light intensity of one pixel, a lower micro-mirror layer may be deposited on the insulation layer 32 of the silicon substrate 31 or the insulation layer 32 may also function as a lower micro mirror, and more than one open holes are formed in the lower supporter 33 on which an upper micro-mirror layer 37 is deposited.

The aforementioned diffraction type optical modulator with open holes employs the upper and lower micro-mirrors in order to reflect or diffract incident lights. Thus, the surface flatness of the micro-mirrors should be precise.

FIGS. 4(a) and 4(b) illustrate directions of inner stresses in the lower supporter and the upper micro-mirror layer in the diffraction type optical modulator and a bending caused by a conflict of the directions. Here, the inner stress refers to a compressive or tensile stress, and the direction of the compressive stress refers to gathering toward the center of a material, while the direction of the tensile stress refers to scattering outward a material from the center from the center. Hereinafter, it is assumed that the directions of the inner stresses between the compressive stresses or between tensile stresses have a same direction, and those between the compressive and tensile stresses have opposite directions.

As shown in FIG. 4(a), the direction of the inner stress in the lower supporter 33 is generally opposite to that in the constituting material of the upper micro-mirror layer 37 deposited on the lower supporter 33. The upper micro-mirror layer 37 is made of metal (Al, Pt, Cr, Ag, and the like), and has a compressive stress 60. The lower supporter 33 is made of silicon nitride (SiNₓ), and has a tensile stress 61.

Therefore, as shown in FIG. 4(b), the lower supporter 33 and the upper micro-mirror layer 37 is convexed toward the upper micro-mirror layer 37.

This bending incurs unflatness of the mirror surface, resulting in lowering the optical efficiency in the optical modulator.

### SUMMARY

Accordingly, the present invention aims to provide a method for manufacturing a MEMS element having a flat surface through heat treatment.

Also, the present invention aims to provide a method for manufacturing an optical modulator having a flat mirror surface, which minimizes bending of an element in order to maximize the optical efficiency of the optical modulator.

Also, the present invention aims to provide a method for manufacturing an optical modulator having a flat mirror surface, which minimizes bending of an element by making inner stresses in a lower supporter and in an upper micro-mirror layer have a same direction through heat treatment Additional aspects and advantages of the present general inventive concept will be set forth in part in the description which follows, and in part will be obvious from the description, or may be learned by practice of the general inventive concept.

One aspect of the present invention provides a manufacturing method for a MEMS element having a flat surface, comprising: (a) depositing a first layer on a substrate, a center portion of the first layer being spaced-apart from the substrate by a predetermined gap; (b) depositing a second layer on the first layer, the inner stresses in the first and second layers having opposite properties; and (c) heat-treating the first and second layers, so that the inner stresses in them have same properties.

Here, the first layer has either a compressive stress or a tensile stress and the second layer has the other one, in the step (b).

Also, the heat-treatment in the step (c) applies heat to the first and second layers to a preset temperature or above, such that the initial inner stress in the first layer has the same properties with the initial inner stress in the second layer.

Also, the heat-treatment in the step (c) applies heat to the first and second layers for a preset time or more, such that the initial inner stress in the first layer has the same properties with the initial inner stress in the second layer.

Also, the heat-treatment in the step (c) applies heat to the first and second layers to a preset temperature or above, such that the initial inner stress in the second layer has the same properties with the initial inner stress in the first layer.

Also, the heat-treatment in the step (c) applies heat to the first and second layers for a preset time or more, such that the initial inner stress in the second layer has the same properties with the initial inner stress in the first layer.

Another aspect of the present invention provides a manufacturing method for an optical modulator having a flat surface, comprising: (a) depositing a lower micro-mirror layer, diffracting incident lights on a part of a top surface of a prepared substrate; (b) adhering a lower supporter on the top surface, the lower supporter being spaced-apart from the lower micro-mirror layer by a predetermined gap; (c) depositing an upper micro-mirror layer, diffracting incident lights on a center portion of the lower supporter; (d) forming driving units on both ends in a length direction of the lower supporter to move a center portion of the lower supporter upward and downward; and (e) heat-treating the upper and lower micro-mirror layers, so that the inner stresses in them have same properties.

Here, the heat treatment in the step (e) applies heat to the first and second layers to or above a first temperature, such that the initial inner stress in the upper micro-mirror layer has the same properties with the initial inner stress in the lower supporter.

Also, the heat treatment in the step (e) applies heat to the first and second layers below a second temperature, at which hillocks are generated on the upper micro-mirror layer.

Also, the heat treatment in the step (e) applies heat to the first and second layers for a first time or more, such that the initial inner stress in the upper micro-mirror layer has the same properties with the initial inner stress in the lower supporter.

Also, the heat treatment in the step (e) applies heat to the first and second layers for a time shorter than a second time, where hillocks are generated on the upper micro-mirror layer.

### BRIEF DESCRIPTION OF THE DRAWINGS

These and other features, aspects, and advantages of the present invention will become better understood with regard to the following description, appended claims, and accompanying drawings where:

FIGS. 1 and 2 illustrate typical configurations of a MEMS element applied to an optical switch, an optical modulator using optical reflection or optical diffraction law.

FIG. 3 is a vertical sectional view of a depressed type piezoelectric optical modulator as another MEMS element.

FIGS. 4(a) and 4(b) illustrate directions of inner stresses in the lower supporter and the upper micro-mirror layer of the diffraction type optical modulator and bending caused by a conflict in the directions.

FIG. 5 is a vertical sectional view of an optical modulator having a flat surface according to an embodiment of the present invention.

FIG. 6 is a vertical sectional view of an optical modulator having a flat surface according to another embodiment of the present invention.

FIGS. 7(a) and 7(b) illustrate the direction of inner stresses changed through heat treatment and its bending improved thereby.

FIG. 8 is a flow chart illustrating a method for manufacturing an optical modulator having a flat surface according to an embodiment of the present invention.

FIG. 9 is a flow chart illustrating a method for manufacturing a MEMS element having a flat surface according to an embodiment of the present invention.

### DETAILED DESCRIPTION

Hereinafter, embodiments of the invention will be described in more detail with reference to the accompanying drawings. In the description with reference to the accompanying drawings, those components are rendered the same reference number that are the same or are in correspondence regardless of the figure number, and redundant explanations are omitted.

The embodiments below can be applied to MEMS elements, which typically transfer/receive signals to/from the outside, but the description below will concentrate on optical modulators among the MEMS elements.

Also, in the present invention, the inner stress refers to a compressive or tensile stress, and the direction of the compressive stress refers to gathering toward the center of a material, while the direction of the tensile stress refers to scattering outward a material from the center. Hereinafter, it is assumed that the compressive or tensile stresses have a same direction among themselves, and the compressive and tensile stresses have opposite directions.

FIG. 5 is a vertical sectional view of an optical modulator having a flat surface according to an embodiment of the present invention.

As shown in FIG. 5, the optical modulator 40 having a flat surface comprises a substrate 101, a lower micro-mirror layer 103, and an element 104.

In the substrate 101 is formed a depressed part providing the element 104 an air gap. This air gap functions as a driving space where a center portion of the element 104, which will be described later, moves upward and downward to reflect or diffract incident lights. Here, since a reflection refers to 0^{th} order diffraction, both reflection and diffraction will be called as diffraction.

An insulation layer 102 is deposited on the substrate 101, and a lower micro mirror layer 103 is deposited on a part of the surface of the insulation layer 102. Bottom of both ends of the element 104 are adhered on both ends of the insulation layer 102 outside the depressed part. The substrate 101 is made of a single material chosen from Si, Al₂O₃, ZrO₂, Quartz, and SiO₂. Otherwise, the substrate 101 can be divided into a lower section and an upper section excluding the depressed part (divided by a dotted line in FIG. 5) to be made of different materials, respectively.

The lower micro-mirror layer 103 is deposited on a top surface of the substrate 101 (or on a top surface of the insulation layer 102, in the case that the insulation layer 102 is deposited on the substrate 101) to diffract incident lights, and formed of metal (for example, Al, Pt, Cr, Ag, and the like), preferably having high optical reflectance. Although the lower micro mirror layer 103 is deposited on the insulation layer 102 as a separate layer in FIG. 5, the insulation layer 102 itself can function as a lower micro-mirror when it is made of material that has light reflecting properties.

The element 104 is a bar or ribbon shape, and comprises a lower supporter 110, a driving unit 120, and an upper micro mirror layer 130.

Bottoms of both ends of the lower supporter 110 are adhered on the both ends of the substrate 101 outside the depressed part, such that a center portion of the element 104 is spaced-apart from the depressed part of the substrate 101. Here, the lower supporter 110 may be made of silicon oxide (for example, SiO₂), silicon-based nitride materials (for example, silicon nitride such as Si₃N₄, SiNₓ), ceramics (for example, Si, ZrO₂, Al₂O₃, and the like), and silicon carbide, etc.

On the top surfaces of the both ends of the lower supporter 110 is disposed the driving unit 120, which supplies driving power to move the center portion of the lower supporter 110 upward and downward. In this embodiment, piezoelectric layers are formed on the both ends of the lower supporter 110 to function as the driving unit 120.

The piezoelectric layer 120, 120′ comprises a lower electrode layer 121, 121′ supplying piezoelectric voltages to a piezoelectric material layer 122, 122′, the piezoelectric material layer 122, 122′ deposited on the lower electrode layer 121, 121′, and an upper electrode layer 123, 123′ deposited on the piezoelectric material layer 122, 122′ and supplying piezoelectric voltages thereto. The piezoelectric material layer 122, 122′ contracts or expands according to a voltage difference between the lower electrode layer 121, 121′ and the upper electrode layer 123, 123′, thereby allowing the center portion of the lower supporter 110 to move upward and downward.

The lower electrode layer 121, 121′ and the upper electrode layer 123, 123′ may be made of Pt, Ta/Pt, Ni, Au, Al, Ti/Pt, IrO₂, or RuO₂, etc., and are deposited by means of thin-film deposition method such as evaporation, sputtering, or the like.

The upper micro-mirror layer 130 is deposited on the entire or part of surface of the lower supporter 110 to diffract incident lights. The upper micro-mirror layer 130 is also made of Al, Pt, Cr, or Ag, etc. like the lower micro-mirror layer 130.

More than one open holes 131a, 131b are formed at a common center portion of the lower supporter 110 and the upper micro-mirror layer 130. Accordingly, the optical modulator 40 diffracts incident lights by using lights reflected from B portion of the upper micro-mirror layer 130 and lights reflected from C portion of the lower micro-mirror layer 103 located in correspondence with the open holes 131a, 131b. Here, the open hole is preferably rectangular, but can also be any closed curve shape such as circular, and elliptical, etc.

In case that the wavelength of an incident light is λ, when a gap distance between the upper micro-mirror layer 130 and the lower micro-mirror layer 103 is an even multiple of λ/4, a pathlength difference between the lights reflected from B portion and C portion becomes nλ (where n is a natural number). Therefore, in the case of a 0^{th} order diffracted light (reflected light), the lights reflected from the upper micro-mirror layer 130 and the lower micro-mirror layer 103 interfere with each other constructively, so that the diffracted light has its maximum brightness. However, in the case of +1^{st} and −1^{st} order diffracted lights, they have a minimum brightness due to a destructive interference.

Meanwhile, when a gap distance between the upper micro-mirror layer 130 and the lower micro-mirror layer 103 is an odd multiple of λ/4, a pathlength difference between the lights reflected from B portion and C portion becomes (2n−1)λ/2 (where n is a natural number). Therefore, in the case of a 0th order diffracted light (reflected light), the lights reflected from the upper micro-mirror layer 130 and the lower micro-mirror layer 103 interfere with each other destructively, so that the diffracted light has its minimum brightness. However, in the case of +1st and −1st order diffracted lights, they have a maximum brightness due to a constructive interference.

Accordingly, by controlling the gap distance between the upper micro-mirror layer 130 and the lower micro-mirror layer 103, lights having diverse brightness can be outputted to express a variety of light intensities.

As the optical modulator 40 comprising the substrate 101, the lower micro-mirror layer 103 and the element 104 is manufactured through a wafer process, bending of the element 104 occurs when initial inner stresses in the constituting materials of the lower supporter 110 and the upper micro-mirror layer 130 have opposite directions.

To prevent the above drawback, a heat treatment is applied to the optical modulator 40 after the wafer process. The heat treatment may be a thermal annealing that heats the optical modulator 41 at a constant temperature, and cools it down slowly to homogenize its inner structure and also to change the inner stresses.

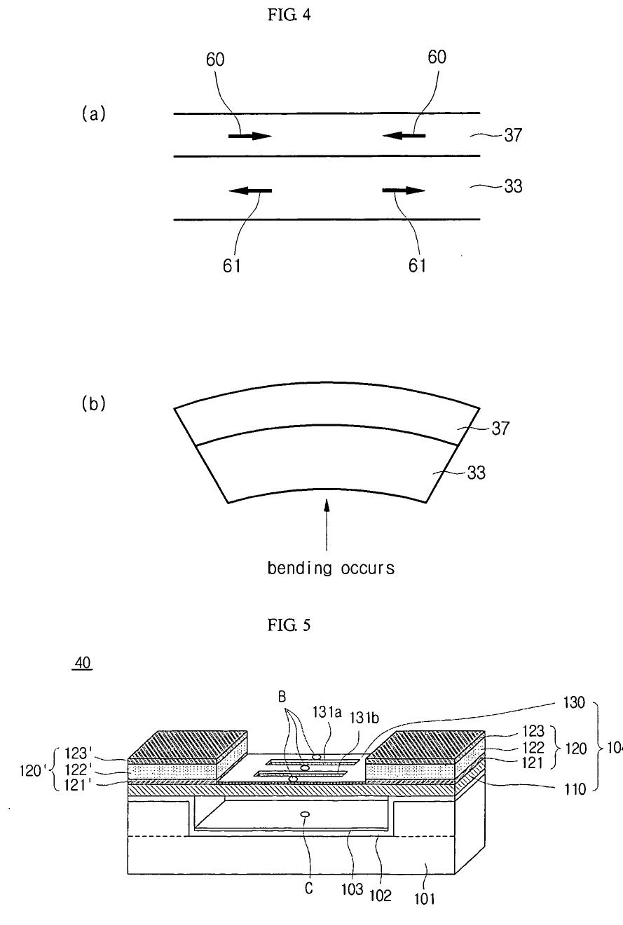

As shown in FIG. 4, the metallic material constituting the upper micro-mirror layer 130 has a compressive stress, but the material constituting the lower supporter 110 has a tensile stress. Otherwise, the upper micro-mirror layer 130 can have a tensile stress while the lower supporter 110 has a compressive stress.

The material constituting the lower supporter 110 has a higher threshold temperature at which the direction of the inner stress changes than the metallic material constituting the upper micro-mirror layer 130. Therefore, in the heat treatment, the threshold temperature at which the direction of the inner stress in the material constituting the lower supporter 110 changes is set as an upper limit temperature, and the threshold temperature at which the direction of the inner stress in the material constituting the upper micro-mirror layer 130 changes is set as a lower limit temperature. Through the heat treatment that heats the optical modulator 40 to a temperature between the lower and upper limit temperatures, and cools it down slowly, only the direction of the inner stress in the upper micro-mirror layer 130 is changed while the direction of the inner stress in the lower supporter 110 is unchanged, so that the two inner stresses have the same direction.

For example, in the case that the lower supporter 110 is made of silicon nitride (SiNₓ), and the upper micro-mirror layer 130 is made of aluminum (Al), the upper limit temperature is approximately 600° C., and the lower limit temperature is approximately 150˜400° C.

The heat treatment can be performed through oven baking process, hot plate process, furnace process, and RTA, etc. To prevent damages, the optical modulator 40 is heated slowly from a room temperature to a certain temperature and cooled down slowly after the heating is finished, as illustrated in the following table.

| Order | Temperature | Duration time |
|---|---|---|
| 1 | room temperature → 300° C. | 5 minutes |
| 2 | 300° C. | 5 minutes |
| 3 | 300° C. → room temperature | 5 minutes |

Accordingly, the bending of the element of the optical modulator 40 is reduced through the heat treatment, resulting in enhancing the optical efficiency.

Here, the heat treatment can be performed based on time besides temperature as follows. A time required for changing the direction of the inner stress in the constituting material of the lower supporter 110 under a certain temperature is set as an upper limit time, and a time required for changing the direction of the inner stress in the constituting material of the upper micro-mirror layer 130 is set as a lower limit time. Through the heat treatment that heats the optical modulator 40 for a time between the lower and upper limit times, and cools it down slowly, only the direction of the inner stress in the upper micro-mirror layer 130 is changed while the direction of the inner stress in the lower supporter 110 is unchanged, so that the two stresses have the same direction.

In addition, the upper limit time and the upper limit temperature can be determined based on a time and a temperature required to generate hillocks in the upper micro-mirror layer 130. The hillock refers to lumps of particles generated due to a rearrangement and further recrystallization of the particles, which occurs during the heat treatment. The hillocks deteriorate the surface properties, causing lowering the optical efficiency. Therefore, it is preferable that the applied temperature and time be controlled within a range where the hillocks are not generated.

Referring to FIGS. 7(a) and 7(b), after the heat treatment, the inner stress 70 in the upper micro-mirror layer 130 has the same direction as the inner stress 61 in the lower supporter 110, whereby the optical modulator 40 can have a flat surface.

For example, in the case that the upper micro-mirror layer 130 is made of aluminum (Al), and an adhesive thin film, which facilitates the adhesion to the lower supporter 110, is made of titanium (Ti), the compressive stress having a minus (−) Mpa value changes into the tensile stress having a plus (+) Mpa value after an the annealing process is performed.

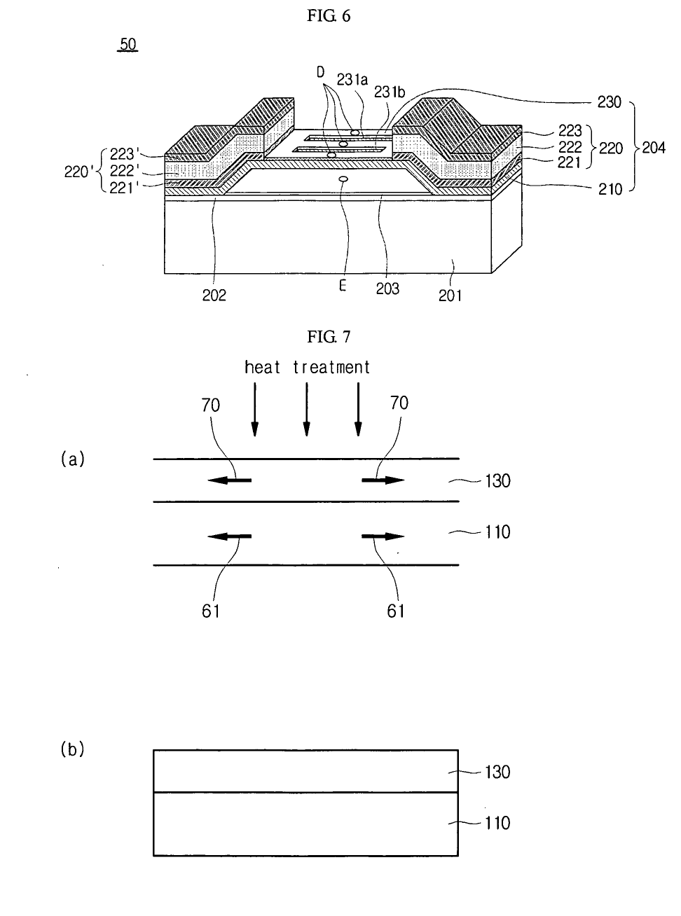

FIG. 6 is a vertical sectional view of an optical modulator having a flat surface according to another embodiment of the present invention.

As shown in FIG. 6, the optical modulator 50 having a flat surface comprises a substrate 201, a lower micro-mirror layer 203, and an element 204.

Unlike FIG. 5, the substrate 201 has an even surface, and the element 204 is protruded from the substrate 201 to provide an air gap. This air gap functions as a driving space where a center portion of the element 204 moves upward and downward to diffract incident lights. On the substrate 201 are deposited an insulation layer 202, and the lower micro-mirror layer 203.

The element 204 is composed of the lower supporter 210, a driving unit 220, an upper micro-mirror layer 230, and is spaced-apart from the lower micro-mirror layer 203 to form the air gap.

The lower supporter 210 spaced-apart by a certain gap from a center portion of the substrate 201 with its center portion being protruded, and both ends of the lower supporter 210 are adhered to the substrate 201.

On the top surface of both ends of the lower supporter 210 is disposed the driving unit 220, which supplies a driving power to move the center portion of the lower supporter 210 upward and downward. In this embodiment, piezoelectric layers are disposed on the both ends of the lower supporter 210 to function as the driving unit 220.

The piezoelectric layer 220, 220′ comprises a lower electrode layer 221, 221′ supplying piezoelectric voltages to a piezoelectric material layer 222, 222′, the piezoelectric material layer 222, 222′ deposited on the lower electrode layer 221, 221′, and an upper electrode layer 223, 223′ deposited on the piezoelectric material layer 222, 222′ and supplying piezoelectric voltages thereto. The piezoelectric material layer 222, 222′ contracts or expands due to a voltage difference between the lower electrode layer 221, 221′ and the upper electrode layer 223, 223′, thereby allowing the center portion of the lower supporter 210 to move upward and downward.

The upper micro-mirror layer 230 is deposited on the entire or part of the surface of lower supporter 210 to diffract incident lights. The upper micro-mirror layer 230 is also made of Al, Pt, Cr, or Ag, etc. like the lower micro-mirror layer 230.

More than one open holes 231a, 231b are formed at a common center of the lower supporter 210 and the upper micro-mirror layer 230. Accordingly, the optical modulator 50 diffracts incident lights by using lights reflected from D portion of the upper micro-mirror layer 230 and lights reflected from E portion of the lower micro-mirror layer 203 located in correspondence with the open holes 231a, 231b. Here, the open hole is preferably rectangular, but can also be any closed curve shape such as circular, and elliptical, etc.

As described above, the distance between the upper micro-mirror layer 230 and the lower micro-mirror layer 203 varies from a distance producing a minimum brightness to a distance producing a maximum brightness, so that the optical modulator 50 can express a variety of light intensities

As the optical modulator 50 comprising the lower micro-mirror layer 203 and the element 204 is manufactured through a wafer process, the element 204 bends when inner stresses in the constituting materials of the lower supporter 210 and the upper micro-mirror layer 230 have opposite directions with each other.

Thus, the heat treatment described above is performed on the optical modulator 50 after the wafer process, so that the inner stress in the upper micro-mirror layer 230 can have the same direction with the inner stress in the lower supporter 210, whereby the optical modulator 50 can have a flat surface.

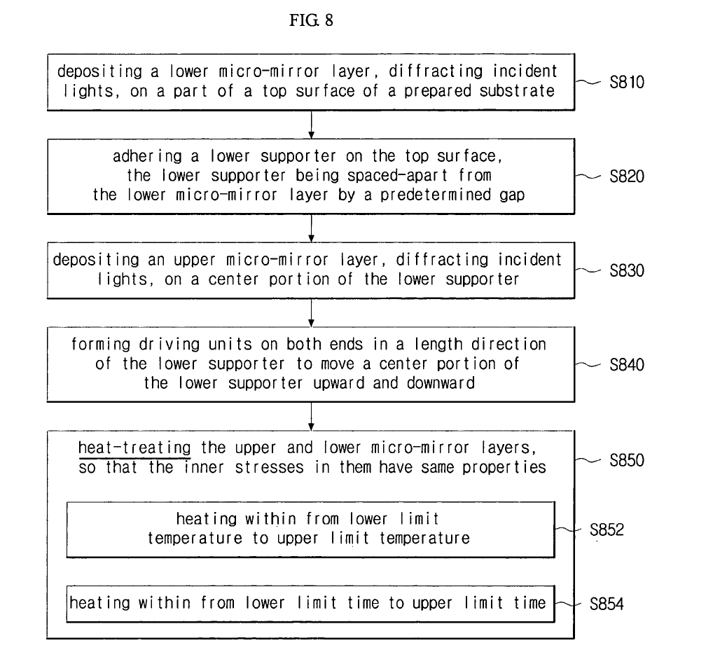

FIG. 8 is a flow chart illustrating a method for manufacturing an optical modulator having a flat mirror surface according to an embodiment of the present invention.

In step S810, a lower micro-mirror layer 103, 203 is deposited on part of a top surface of a prepared substrate 101, 201 to diffract incident lights. In step S820, on the top surface of the substrate 101, 201 is adhered a lower supporter 110, 210 to be spaced from the lower micro-mirror layer 103, 203 by a predetermined gap. In step S830, an upper micro-mirror layer 130, 230 is deposited to diffract lights incident to a center portion of the lower supporter 110, 210. In the steps through S810 to S830, the lower micro-mirror layer 103, 203 and the upper micro-mirror layer 130,230 are deposited by depositing metal having a high reflectance (for example, aluminum (Al)) by means of a deposition method such as sputtering and evaporation, etc. Here, in order for strong adhesion of aluminum, an adhesive thin film made of titanium (Ti) can further be provided.

More than one open holes 131a, 131b, or 231a, 231b may be formed in the lower supporter 110, 210 and the upper micro-mirror layer 130, 230. The reflection or diffraction of the lights incident through the open holes will not be explained again since it was already covered in the above descriptions.

In step S840, driving units 120, 220, allowing a center portion of the lower supporter 110, 210 to move upward and downward, are formed on both ends in a length direction of the lower supporter 110, 210. The driving unit 120, 220 may be a piezoelectric layer which contracts or expands due to piezoelectric voltages to provide driving power to the lower supporter 110, 210.

As a result of the above process, an optical modulator 40, 50 is manufactured. Here, the inner stresses in the lower supporter 110, 210 and upper micro-mirror layer 130, 230 of this optical modulator have opposite directions, thereby generating bending of an element 104, 204 and lowering the optical efficiency.

Therefore, in step S850, the above described heat treatment is performed to make the inner stress in the upper micro-mirror layer 130, 230 have the same direction with the inner stress in the lower supporter 110, 210.

Here, heat treatment is performed by heating the optical modulator up to the lower limit temperature or above, or for the lower limit time or more, and then cooling it down slowly, whereby the inner stresses in the upper micro-mirror layer 130, 230 and the lower supporter 110, 210, which first had opposite directions, now have the same direction.

In addition, the heat treatment is performed to heat the optical modulator 40, 50 below the upper limit temperature or for less than the upper limit time, which is determined based on a threshold temperature or required time where the hillocks are generated in the upper micro-mirror layer 130, 230. For example, in the case that the upper micro-mirror layer 130, 230 is made of aluminum (Al), even when heat is applied to 300-400° C., the hillocks are not generated enough to lower the optical efficiency.

In short, the heat treatment is performed within a temperature between the lower limit temperature and the upper limit temperature (step S852), or for a time between the lower limit time and the upper limit time (step S854).

In the present invention, unlike FIGS. 5 and 6, the optical modulator having a flat surface may have open holes arranged in a transverse direction. Furthermore, a plurality of the optical modulators may be placed laterally in order to provide a variety of diffracted lights, thereby expressing a variety of light intensities corresponding to a plurality of pixels. Meanwhile, this description concentrates on a case where a single piezoelectric material layer is disposed, but a multi-layered type composed of several longitudinally stacked piezoelectric material layers can also be provided.

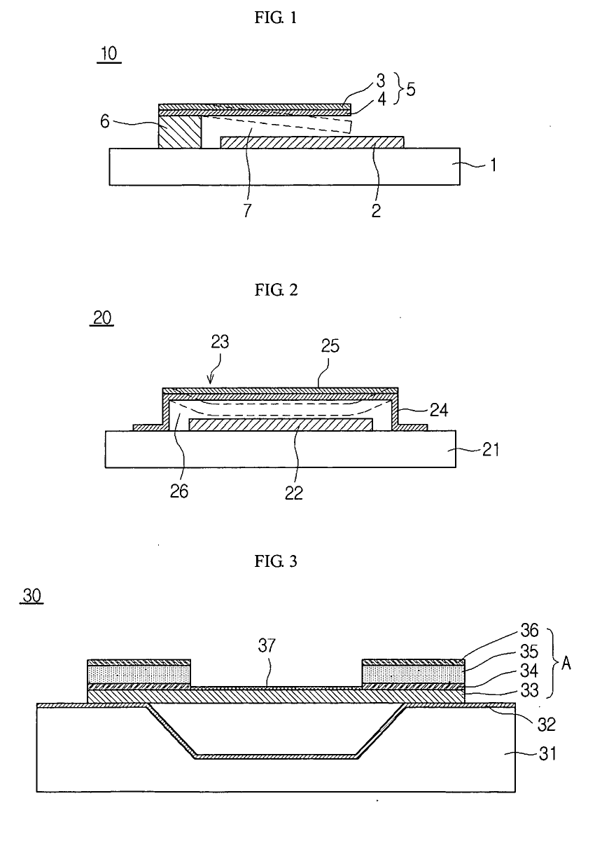

Also, the present invention was hereto described with an example of a piezoelectric type optical modulator included in an indirect type. However, it can also be applied not only to an electrostatic type illustrated in FIGS. 1 and 2 but also a direct type controlling the on/off states of the light directly.

Furthermore, although the above embodiments concentrate on the optical modulator, they can also be applied to a MEMS element, a mechanical part of which is composed of two or more layers spaced from the substrate and having different inner stresses.

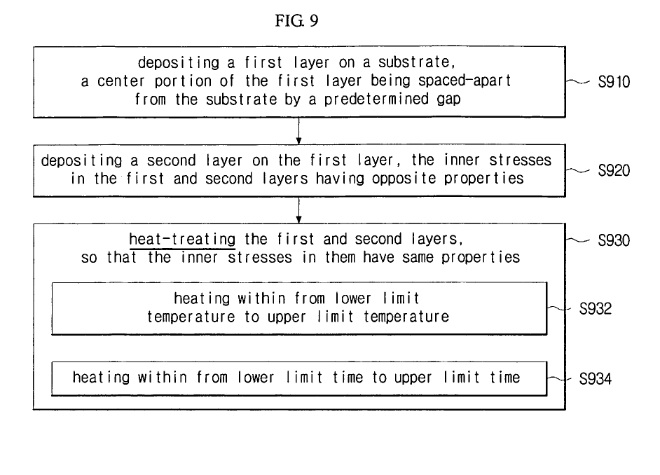

FIG. 9 is a flow chart illustrating a method for manufacturing a MEMS element according to an embodiment of the present invention.

In step S910, a first layer is deposited on a substrate. A center portion of the first layer is spaced-apart from the substrate by a predetermined gap. With this gap, the MEMS element can perform mechanical motions.

In step S920, a second layer is deposited on the first layer, the inner stresses in them having opposite directions. Here, the inner stress in the first layer is either a compressive stress or a tensile stress, and the inner stress in the second layer is the other one.

In step S930, a heat treatment is performed on the MEMS element, such that the inner stresses in the first and second layers have a same direction. The heat treatment may be performed at a temperature ranging from the lower limit temperature and to the upper limit temperature (step S932), or for a time ranging from the lower limit time and the upper limit time (step S934).

While the invention has been described with reference to the disclosed embodiments, it is to be appreciated that those skilled in the art can change or modify the embodiments without departing from the scope and spirit of the invention or its equivalents as stated below in the claims.

What is claimed is:

1. A manufacturing method for a MEMS element having a flat surface, comprising:
(a) depositing a first layer on a substrate, a center portion of the first layer being spaced-apart from the substrate by a predetermined gap;
(b) depositing a second layer on the first layer, the inner stresses in the first and second layers having opposite properties; and
(c) heat-treating the first and second layers, so that the inner stresses in them have same properties.

2. The manufacturing method for a MEMS element of claim 1, wherein the first layer has either a compressive stress or a tensile stress, and the second layer has the other one, in the step (b).

3. The manufacturing method for a MEMS element of claim 1, wherein the heat-treatment in the step (c) applies heat to the first and second layers to a preset temperature or above, such that the initial inner stress in the first layer has the same properties with the initial inner stress in the second layer.

4. The manufacturing method for a MEMS element of claim 1, wherein the heat-treatment in the step (c) applies heat to the first and second layers for a preset time or more, such that the initial inner stress in the first layer has the same properties with the initial inner stress in the second layer.

5. The manufacturing method for a MEMS element of claim 1, wherein the heat-treatment in the step (c) applies heat to the first and second layers to a preset temperature or above, such that the initial inner stress in the second layer has the same properties with the initial inner stress in the first layer.

6. The manufacturing method for a MEMS element of claim 1, wherein the heat-treatment in the step (c) applies heat to the first and second layers for a preset time or more, such that the initial inner stress in the second layer has the same properties with the initial inner stress in the first layer.

7. A manufacturing method for an optical modulator having a flat surface, comprising:
(a) depositing a lower micro-mirror layer, diffracting incident lights, on a part of a top surface of a prepared substrate;
(b) adhering a lower supporter on the top surface, the lower supporter being spaced-apart from the lower micro-mirror layer by a predetermined gap;
(c) depositing an upper micro-mirror layer, diffracting incident lights, on a center portion of the lower supporter;
(d) forming driving units on both ends in a length direction of the lower supporter to move a center portion of the lower supporter upward and downward; and
(e) heat-treating the upper and lower micro-mirror layers, so that the inner stresses in them have same properties.

8. The manufacturing method for an optical modulator of claim 7, wherein the heat treatment in the step (e) applies heat to the first and second layers to or above a first temperature, such that the initial inner stress in the upper micro-mirror layer has the same properties with the initial inner stress in the lower supporter.

9. The manufacturing method for an optical modulator of claim 8, wherein the heat treatment in the step (e) applies heat to the first and second layers below a second temperature, at which hillocks are generated on the upper micro-mirror layer,

10. The manufacturing method for an optical modulator of claim 7, wherein the heat treatment in the step (e) applies heat to the first and second layers for a first time or more, such that the initial inner stress in the upper micro-mirror layer has the same properties with the initial inner stress in the lower supporter.

11. The manufacturing method for an optical modulator of claim 10, wherein the heat treatment in the step (e) applies heat to the first and second layers for a time shorter than a second time, where hillocks are generated on the upper micro-mirror layer.
